(19) United States
(12) Patent Application Publication
(10) Pub. No.: US 2025/0295146 A1
(43) Pub. Date: Sep. 25, 2025

(54) FROZEN FUDGE DRINK, DRINK MIX COMPOSITION, AND METHOD FOR PRODUCING FROZEN FUDGE DRINK

(71) Applicant: CALICO COTTAGE, INC., Amityville, NY (US)

(72) Inventors: Zeynep Gungor, Dix Hills, NY (US); Danielle Rourke, Commack, NY (US); Mark Wurzel, Muttontown, NY (US); Thomas Montoya, Kings Park, NY (US); Bruce Molfetto, Ridge, NY (US)

(21) Appl. No.: 19/086,787

(22) Filed: Mar. 21, 2025

Related U.S. Application Data
(60) Provisional application No. 63/568,421, filed on Mar. 21, 2024.

(51) Int. Cl. A23L 2/60; A23F 5/46; A23L 2/38; A23L 2/39; A23L 2/56; A23L 2/66

(52) U.S. Cl. CPC A23L 2/60; A23F 5/465; A23L 2/38; A23L 2/39; A23L 2/56; A23L 2/66

(57) ABSTRACT

A fudge-based frozen beverage comprises a blended combination of flavored fudge, a unique powdered drink mix having at least a dry sweetener and a thickener, and water, and ice. Upon completion, a rich and creamy frozen fudge drink is created. The unique powdered drink mix includes a sucrose-based extra fine dry sweetener with at least 85% of its particles, with agglomerates broken down, having a size smaller than or equal to 44 microns, as well as a thickener, a texture enhancer, and a flavoring agent, among optionally other ingredients. In another version, at least 89% of the particles are extra fine dry sweetener are 44 microns or less. Other versions prescribe the size of all particles of the sucrose-based extra fine dry sweetener. The powdered drink mix may include other ingredients to enhance taste, texture, flavor, consistency, whitening, and stabilization. The invention also includes a novel process for making the fudge-based frozen beverage by adding a set amount of the unique powdered drink, along with specific amounts of a selected flavored fudge, water, and ice into a blender and blending for a preset period of time. Variations of this process include adding instant coffee among other ingredients. In another version, the ingredients without the ice are first blended, and then the ice is added before the final blending step to produce the rich and creamy fudge-based frozen beverage.

### REFERENCE TO RELATED APPLICATION

This application claims the benefit of U.S. Provisional Application Ser. No. 63/568,421, filed Mar. 21, 2024, the entire disclosure of which is incorporated herein by reference.

### BACKGROUND OF THE INVENTION

### 1. Field of the Invention

The present invention relates to the innovative field of food processing techniques, specifically focusing on a novel system and compositional methodology for transforming solid confectionery items, particularly fudge, into consumable frozen beverage forms. This invention addresses and overcomes the limitations of traditional methods in creating stable, creamy, and flavorful frozen beverages from dense confectionery items.

### 2. Description of the Related Art

Frozen drinks are made from a large variety of ingredients, offering endless possibilities for flavor and creativity. These types of beverages often are concocted from concentrate powders or an assortment of fruits and juices, and various other ingredients that are then typically combined with ice. With such versatility, the art of making frozen drinks offers a delightful experience for both creators and consumers alike.

Frozen drinks from concentrates offer convenience, but there are notable downsides. One shortcoming is the lack of distinct layers, which results in a less satisfying taste. Concentrate-based beverages often miss the intricate and layered flavor profile consumers desire.

A further drawback of concentrate-based drinks is their inconsistency that, in turn, lead to too much variability in quality and taste. Consequently, consumers sometimes are disappointed.

Frozen fruit-based drinks also have various shortcomings, including difficulties in maintaining fruit freshness, difficult preparation processes, and heightened acidity levels, to name a few.

Quite different from concentrate and fruit-based frozen drinks, U.S. Pat. No. 6,835,406, which is owned by Calico Cottage, Inc., the applicant hereof, is directed towards a frozen fudge drink invented over 20 years ago and combines chocolate fudge pieces with water and ice in a then-novel manner to produce a creamy and tasty fudge-based frozen drink. U.S. Pat. No. 6,835,406 is incorporated herein by reference.

Nevertheless, the culinary industry has lacked an effective method for converting any flavor of solid fudge into a frozen drink without compromising texture, flavor, and stability.

### OBJECTS, BENEFITS AND SUMMARY OF THE INVENTION

The present invention, called the Whirzle system by the applicant hereof, embodies a pioneering approach, utilizing a specific compositional strategy to maintain the integrity and appeal of the original confectionery while transforming it into a new consumable form.

The inventive frozen fudge drink of the present invention includes fudge in a large variety of fudge flavors, not just chocolate. Any number of fudge flavors are used to produce the inventive frozen fudge drink. As an additional feature of the invention, the ultimate consumer, who can be a customer of a retailer, can select the flavor of fudge that is used (e.g., by the retailer) to make the frozen fudge drink.

In accordance with a further object and benefit, the frozen fudge drink is made using a novel, unique drink mix to produce a frozen fudge drink that has a consistently high-quality taste and texture.

In accordance with another object and benefit, the invention encompasses a method for producing the inventive frozen fudge drink that is user-friendly and straightforward to implement. For instance, the straight-forward method allows retailers of the frozen fudge drink to easily train employees to properly make the inventive frozen fudge drink.

As another object and benefit of the invention, the inventive frozen fudge drink is quickly and easily made with the use of a single blender and without requiring the use of other more complicated equipment and without having to implement multiple complicated steps.

As a further object and benefit of the invention, the inventive frozen fudge drink is made with ice that can be of any typical shape or size without impacting quality and consistency of the product. Accordingly, a retailer, homeowner or other entity/person carrying out the present invention can purchase ice from nearly any source or use any type of ice making machine to make the ice for use in the present invention.

Other objects and benefits are described below and/or would be appreciated from the description herein.

The present invention, in brief summary, is a frozen fudge drink that includes the herein-described novel drink mix in amounts described below, a certain amount of fudge in any number of flavors, along with water and ice. The respective amounts of each ingredient depend on various factors as discussed herein.

The present invention also encompasses the process of making the inventive frozen fudge drink, wherein four ingredients are combined and then blended to produce the frozen fudge drink. As will be discussed, the blending process employs an electric blender. The blender can be preprogrammed so that blending is carried out in accordance with a preset blending speed and duration.

The present invention also encompasses the herein-described unique drink mix.

In accordance with a first embodiment of the invention, a fudge-based beverage comprises, in summary, a blended combination of flavored fudge, a powdered drink mix having at least an extra fine dry sweetener and a thickener, along with water, and ice.

As an aspect of the invention, the dry sweetener includes a sucrose-based extra fine dry sweetener with at least 89% of particles, with agglomerates broken down, having a size smaller than or equal to 44 microns. In a variation, the sucrose-based extra fine dry sweetener has at least 85% of particles, with agglomerates broken down, having a size smaller than or equal to 44 microns.

As a further aspect of the invention, the dry sweetener includes a sucrose-based extra fine dry sweetener with an average particle size, with agglomerates broken down, of between 27 and 31 microns. In a particular version, the average particle size is substantially 29 microns.

As yet a further aspect of the invention, the powdered drink mix comprises sucrose-based extra fine dry sweetener that is substantially 22.4% by weight of the powdered drink mix; dextrose that is substantially 18% by weight of the powdered drink mix; corn syrup solid that is substantially 16% by weight of the powdered drink mix; non-fat dry milk that is substantially 15% by weight of the powdered drink mix; and at least one additional ingredient to affect at least one of texture, flavor, consistency, whitening, and stabilization.

As a feature of this aspect, the powdered drink mix also includes xanthan gum that is substantially 1% by weight of the powdered drink mix; maltodextrin that is substantially 5% by weight of the powdered drink mix; non-dairy creamer that is substantially 17% by weight of the powdered drink mix; non-fat dry milk that is substantially 15% by weight of the powdered drink mix; whey protein that is substantially 4% by weight of the powdered drink mix; and top flow table salt that is substantially 0.1% by weight of the powdered drink mix.

As a further aspect of the invention, the powdered drink mix comprises: sucrose-based extra fine dry sweetener that is substantially 70% by weight of the powdered drink mix; dextrose that is substantially 7% by weight of the powdered drink mix; corn syrup solid that is substantially 6% by weight of the powdered drink mix; non-fat dry milk that is substantially 4.9% by weight of the powdered drink mix; and at least one additional ingredient to affect at least one of texture, flavor, consistency, whitening, and stabilization.

As an additional aspect of the invention, 16 ounces of the blended combination include: ¼ pound by weight of the flavored fudge; 1.1 ounces by volume of the powdered drink mix; 3 ounces by volume of water; and 16 ounces by volume of ice.

As yet a further aspect of the invention, the blended combination includes instant coffee.

As still yet another aspect of the invention, all the ingredients of the fudge-based beverage, except for the ice, are stable at room temperature.

In accordance with a method embodiment of the invention, a method of producing a fudge-based blended beverage, comprises, in summary, the steps of: obtaining a flavored fudge; cutting the flavored fudge into pieces and adding the pieces of the flavored fudge to a blender; adding a predetermined amount of powdered drink mix that has at least a dry sweetener and a thickener to the blender; adding a predetermined amount of water to a blender; adding ice to the blender; and blending the flavored fudge, water, powdered drink mix, and ice to produce the fudge-based blended beverage.

As an aspect of this embodiment, the flavored fudge is selected from a plurality of pre-made flavored fudges.

As another aspect of this embodiment, blending is carried out by a pre-programmed blender in accordance with a first mode corresponding to a first preset period of time at a first preset speed of operation or in accordance with a second mode corresponding to a second preset period of time at a second preset speed of operation. The blending is carried out by the blender in the first mode or in the second mode based on a flavor of the flavored fudge added to the blender.

As further multiple aspects/variations of this embodiment, the powdered drink mix includes any of the above briefly summarized ingredients as set forth in the various aspects mentioned herein.

As yet another aspect of this method embodiment, the amount of the fudge-based blended beverage to be produced is determined (e.g., 16 ounces or a different amount), and providing at least ¼ pound by weight of the flavored fudge, at least 1.1 ounces by volume of the powdered drink mix, at least 3 ounces by volume of water, at least 16 ounces by volume of ice, and then proportionally adjusting amounts of these ingredients to be added to the blender if the determined amount of the fudge-based blended beverage to be produced is different from 16 ounces.

As yet a further aspect of this embodiment, all the ingredients added to the blender, except for the ice, are stable at room temperature.

As still yet another embodiment of this embodiment, instant coffee is added to the blender prior to the blending step.

As another aspect, prior to the blending step, at least one additional ingredient selected from the group consisting of vanilla, caramel, and a cut piece of fruit is added to the blender.

As an additional aspect, the process of this embodiment comprises carrying out a first blending step for a first predetermined period of time before the ice is added to the blender to blend the pieces of flavored fudge, the powdered drink mix, and the water to produce a first blended combination. The ice is then added to first blended combination in the blender and then the blender blends all the ingredients for a second predetermined period of time to produce the fudge-based blended beverage. In a version, the first and second periods of time are different.

As a further aspect of the process embodiment, both blending steps are carried out by a pre-programmed blender having at least two modes of operation in which blending the pieces of flavored fudge, the powdered drink mix, and the water to produce the first blended combination during the first blending step is automatically carried out for said first predetermined period of time upon user initiation of a first mode of operation of the blender. The step of blending the flavored fudge, water, powdered drink mix, and ice to produce the fudge-based blended beverage is automatically carried out for the second predetermined period of time upon user initiation of a second mode of operation of the blender.

In accordance with a further embodiment of the invention, a composition of a powdered drink mix for use to produce a fudge-based beverage, comprises, in summary: a sucrose-based extra fine dry sweetener with at least 85% of particles, with agglomerates broken down, having a size smaller than or equal to 44 microns; a thickener; a texture enhancer; and a flavoring agent.

In accordance with various multiple aspects of this composition embodiment, the composition has any of the foregoing summarized requirements and/or additional ingredients and other components of the summarized powdered drink.

As illustrated from the following detailed description, the present invention encompasses various additional objects, benefits, aspects, and features, along with yet further objects, benefits and features that would be readily apparent to those of ordinary skill in the art.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 pictorially shows the frozen fudge drink of the present invention using different fudge flavors along with representative fudge that was used to make the frozen fudge drinks.

FIG. 2. illustrates exemplary fudge with different flavors, shapes, layers and colors (color not represented in the figures).

FIG. 3 is a flow chart of the process of making the frozen fudge drink in accordance with certain embodiments of the invention.

FIG. 4 is a flow chart of the process of making the frozen fudge drink in accordance with additional embodiments of the invention.

### DETAILED DESCRIPTION OF INVENTION

As introduced above, the present invention is a novel frozen fudge drink that is made with fudge available in a diverse range of flavors. As will be described in greater detail, the frozen fudge drink is prepared by easily combining and quickly blending a specially formulated novel drink mix along with the selected fudge, water and ice.

In accordance with the present invention, the specially formulated novel drink mix, referred to herein as the inventive drink mix (or “drink mix”), is a powdered composition designed to transform fudge, which possesses a distinct texture and physical form, into a smooth and creamy frozen beverage, thereby altering its texture and physical appearance significantly.

Utilizing ingredients from Calico Cottage to produce fudge in its conventional form results in a smooth and creamy consistency with minimal to no perceptible grittiness, offering an enjoyable consumption experience. The fudge's texture is engineered to be firm yet effortlessly consumable, facilitating easy biting and mastication.

When employed in the preparation of the frozen beverage, the inventive drink mix converts a 4 oz. portion of fudge, measured by weight, along with water and ice, into a rich and creamy beverage. The resultant frozen fudge drink bears a resemblance to a dense, frozen milkshake in terms of its consistency and mouthfeel.

Furthermore, the latest iterations of the inventive drink mix are engineered to serve as a vehicle for various fudge flavors, thereby accommodating a broad spectrum of flavor preferences. This is achieved through compatibility with over 300 distinct fudge flavor varieties offered by Calico Cottage, enabling a diverse array of flavor options for the frozen beverage.

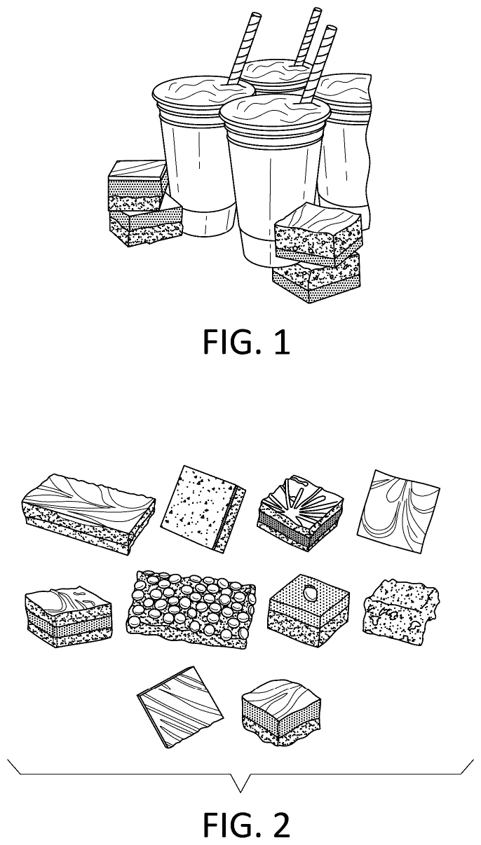

FIG. 1 of the accompany drawings shows the inventive frozen fudge drink using different fudge flavors in different colors (with colors not represented in the black and white figure) along with representative fudge that was used to make the frozen fudge drinks.

### The Drink Mix

The drink mix is, along with fudge, the foundation of the frozen fudge drink of the present invention and, thus, the drink mix is initially described in detail. As will be appreciated, the drink mix contributes a unique flavor and texture profile and other beneficial attributes, which enhances the overall taste experience.

In accordance with the present invention, the drink mix is a mix of various ingredients and, in the bulk of the embodiments, includes an extra-fine dry sweetener, a thickener, and flavorings. In certain embodiments, additional sweeteners, such as various types of sugars, are included along with salt (in select embodiments), and in yet further embodiments artificial flavorings.

As will be discussed further, an exemplary ingredient, in certain embodiments, is the free-flowing, dry fondant sugar system sold under the product name Nulofond®. The Nulofond® sugar system is a fondant mixture manufactured by and available from Domino Foods, Inc., a unit of ASR Group.

As described at the website, https://www.dominospecialtyingredients.com/products/fondants-icing sugars-nulofond, which is incorporated herein by reference. The website provides the following description of the Nulofond® sugar system: “A free-flowing dry fondant sugar system prepared by processing sucrose into an agglomerated base for use in confections. An ultra-fine particle size ensures dispersity of fats, oils, colors, flavors and emulsifiers for no grit. No anti-caking agents are included. Nulofond® is a rapid wet-out cold process fondant and is used by confectioners for cream centers, cordials, fudge, glazes, drizzles, and swirls.”

In accordance with the present invention, the Nulofond® sugar system is well suited to be an ingredient of the inventive drink mix since a substantial portion of its particles have an ultimate particle size of no greater than 44 microns. In general, the Nulofond® sugar system includes roughly (on average) 89.1% particles smaller than or equal to 44 microns, and 10.9% particles larger than 44 microns.

It is appreciated, however, that suitable substitutes may be used in place of the Nulofond® sugar system and thus the drink mix of the present invention is not limited exclusively to including the Nulofond® sugar system. As discussed herein, alternatives may be employed including suitable alternative dry sweeteners that have ultimate particle sizes comparable to those in the Nulofond® sugar system.

In certain embodiments, the extra-fine dry sweetener that is employed within the inventive drink mix has an ultimate particle size on average of substantially 29 microns. In other embodiments, the extra-fine dry sweetener has an average particle size that falls within a range of 27-31 microns. In various embodiments, the extra-fine dry sweetener that is employed in the inventive drink mixture is a sucrose-based fondant mixture with comparable particles sizes similar to those of the other embodiments.

In preferred embodiments, a proprietary version of the sugar system described herein, called the extra fine sugar system herein, is employed. In the extra fine sugar system, the ultimate particle size of over 89% of the sugar after the agglomerates are broken down are smaller than 44 microns in size. Moreover, the extra fine sugar system contains a greater amount of smaller agglomerates than the Nulofond® sugar system, which allows the agglomerates to break down faster when blending the powder with water, ice and fudge. As further discussed, this ensure that the end product of the frozen fudge drink does not have a gritty mouthfeel.

In accordance with a particular embodiment of the present invention, the drink mix has the formulation set forth in Formula 1 shown in Table 1 below:

TABLE 1
Formula 1

70% extra fine sugar system
7% dextrose
6.5% non-dairy creamer
6% corn syrup solid
4.9% non-fat dry milk
2% maltodextrin
1.5% whey protein
1% natural vanilla powder
1% xanthan gum
0.1% top flow table salt

Formula 1 was derived after extensive research, testing, and feedback. Testers voiced their preference for the above Formula 1 based on the resulting exceptional taste and flavor profile. Through surveys, taste tests, and analysis, it became evident that Formula 1 stood out among other options, resonating most with the testers' discerning palates and culinary preferences. This selection is a testament to the commitment to providing products that not only meet but should exceed customer expectations, ensuring an unparalleled experience with each sip presents an opportunity to cater to different tastes and preferences, allowing for flexibility in the application of the inventive drink mix.

In accordance with another particular embodiment of the present invention, the inventive drink mix has a formulation Formula 2 shown in Table 2 below.

TABLE 2
Formula 2

22.40% Extra-Fine Sugar System
18% dextrose
17% non-dairy creamer
16% corn syrup solid
15% non-fat dry milk
5% maltodextrin
4% whey protein
1.5% natural vanilla powder
1% xanthan gum
0.1% top flow table salt

As compared to Formula 1, the change in formulation reduced the overall sweetness allowing for greater appeal across a variety of consumer demographics. Since the primary ingredient of fudge is sugar, during development and testing of the present invention, it was discovered that the addition of a greater amount of sugar within the inventive drink mix could be reduced to satisfy certain palates. Accordingly, Formula 2 has a sugar content in the form of the extra fine sugar system that is substantially less than the amount in Formula 1.

A brief explanation of each ingredient is presented below.

The extra fine sugar system and its equivalents represent a sugar component enhancement, which provides a product with less grit as compared to standard sugar. As mentioned earlier, the extra fine sugar system ensures that the ultimate particle size of over 89% of the sugar after the agglomerates are broken down are smaller than 44 microns in size. Moreover, the extra fine sugar system contains a greater amount of smaller agglomerates which allows the agglomerates to break down faster when blending the powder with water, ice and fudge. All of this in turn ensures that the inventive frozen fudge drink does not have a gritty mouthfeel.

The selection of extra fine sugar system ensures a refined sugar particle size, predominantly under 44 microns, enhancing dissolution and preventing a gritty mouthfeel in the final beverage.

Dextrose provides the following benefits of the inventive frozen fudge drink.

Freezing Point Depression: Dextrose lowers the freezing point of the liquid, which is crucial for creating the right consistency in frozen beverages. This property helps prevent the drink from becoming a solid block of ice, ensuring it maintains a slushy or semi-frozen texture that's enjoyable to consume.

Texture Improvement: The addition of dextrose influences the crystallization of ice, promoting smaller ice crystals. Smaller crystals contribute to a smoother, more palatable texture in the frozen fudge drink, as opposed to larger crystals, which can create a grainy texture.

Enhanced Flavor Release: At colder temperatures, our taste buds are less sensitive, which can diminish the perceived intensity of flavors. Dextrose, being a simple sugar, enhances flavor perception in the frozen fudge drink, ensuring the taste remains strong and appealing even when cold.

Consistency and Body: Dextrose adds body and viscosity to the frozen fudge drink, contributing to a fuller mouthfeel. This is particularly important since a thin or watery consistency will detract from the overall drinking experience.

Stabilization: dextrose helps stabilize emulsions and suspensions, ensuring that the components of the frozen fudge drink (like fruit purees, flavorings, and colorings) remain evenly distributed and don't separate or settle at the bottom.

The non-dairy creamer provides the following benefits with the frozen fudge drink.

Creaminess and Texture: Non-dairy creamers provide a creamy texture and mouthfeel that is similar to that of dairy-based creamers but without using any lactose or dairy products.

Flavor Enhancement: These creamers enhance the overall flavor profile of the drink. They add a hint of richness and smoothness, making the frozen fudge drink more indulgent and appealing.

Emulsification: Non-dairy creamers contain emulsifiers, which help blend water and oil components, leading to a more stable and uniform texture in the frozen fudge drink. This is particularly helpful to prevent or minimize separation or the formation of ice crystals.

Whitening Effect: In coffee-based and other versions of the frozen fudge drink, non-dairy creamers provide a whitening effect, which is aesthetically pleasing to many consumers.

Versatility: Non-dairy creamers can be flavored or sweetened, offering additional customization options for frozen fudge drink formulations. This allows manufacturers and consumers to create a variety of taste profiles within the same beverage category.

The increase in the non-dairy creamer in Formula 2 boosts the creaminess and flavor complexity of that version of the beverage. But in each version, the creamer's emulsification capabilities are crucial for maintaining a homogeneous and appealing texture, especially in a frozen state.

Corn syrup solids provide the following benefits within the frozen fudge drink.

Texture and Consistency: They help in controlling the texture and consistency of the frozen fudge drink. By influencing the freezing point and reducing the size of ice crystals, corn syrup solids contribute to a smoother and more palatable texture, which helps the quality of the frozen fudge drink.

Freezing Point Depression: Similar to dextrose, corn syrup solids lower the freezing point of the liquid, preventing the drink from becoming too hard or icy. This ensures that the drink maintains a slushy or semi-solid state, which is easier to consume.

Enhanced Mouthfeel: They contribute to a richer mouthfeel, making the drink feel more satisfying and indulgent.

This ingredient plays a pivotal role in modulating the freezing characteristics and ensuring a consistent, enjoyable texture devoid of crystalline granularity.

Non-fat dry milk powder provides the following benefits.

Improved Texture and Body: Non-fat dry milk adds body and creaminess to the frozen fudge drink without the added fat content. This makes the beverage feel richer and more satisfying on the palate, even though it's a lower-calorie option compared to whole milk powder.

Flavor Enhancement: While non-fat dry milk doesn't have as rich a flavor as whole milk powder, it still contributes to a more complex flavor profile in the frozen fudge drink, adding a subtle milky or creamy note that can enhance other ingredients.

Emulsification Properties: Non-fat dry milk helps stabilize emulsions, ensuring that the various ingredients in the frozen fudge drink mix well and stay integrated, preventing separation or settling.

Foaming Capability: In certain embodiments of the frozen fudge drink, non-fat dry milk contributes to foaming properties, helping to create a frothy texture that is visually appealing and enjoyable to drink.

This ingredient contributes to a richer, more indulgent mouthfeel, complementing the overall sensory experience.

Maltodextrin provides the following benefits.

Texture and Body: Maltodextrin improves the texture and body of the frozen fudge drink, giving a fuller, more satisfying mouthfeel. This is particularly valuable in lower-fat or lower-calorie products where you might want to mimic the richness of a full-fat counterpart.

Sweetness: While maltodextrin is less sweet than sugar, it provides a mild sweetness, which helps to achieve the desired sweetness level without overpowering the drink with sugariness, allowing other flavors to shine through.

Freezing Point Depression: Like other sugars and polysaccharides, maltodextrin lowers the freezing point of water, which helps to prevent the drink from becoming too solid. This is essential for maintaining the desired slushy or semi-frozen consistency.

Stabilization: Maltodextrin helps stabilize the drink by preventing the crystallization of sugars and the formation of large ice crystals. This results in a smoother texture and extends the shelf life by maintaining the quality of the drink over time.

Carrier for Flavors and Colors: Maltodextrin is an excellent carrier for flavors and colors, helping to distribute these ingredients evenly throughout the drink. It ensures that every sip has a consistent taste and appearance.

The maltodextrin enhances the beverage's body and mouthfeel while providing a stable matrix for flavor and color components, ensuring consistency in every sip.

Whey Protein provides the following benefits within the frozen fudge drink:

Texture: Whey protein improves the texture of the frozen fudge drink, adding a creamy consistency. It helps thicken the beverage, providing a richer mouthfeel that can enhance the overall drinking experience.

Flavor: While whey protein itself has a mild taste, it carries other flavors well. This allows the other ingredients' flavors to stand out, enhancing the overall taste of the drink.

The whey protein serves to augment the beverage's texture, introducing a creamy, smooth consistency that enriches the drinking experience while supporting flavor enhancement.

Xanthan Gum ensures optimal viscosity and texture, preventing phase separation and ice crystal formation, which are critical for the beverage's quality and consumer appeal.

Natural Vanilla Powder is an authentic flavor enhancer to deepen the flavor complexity, offering a genuine vanilla undertone that enhances the fudge's inherent taste profile.

Top Flow Table Salt is a flavor balancer and enhancer, which amplifies the beverage's flavor dimensions, providing a subtle but crucial balance to the sweetness and enriching the overall taste experience.

The above formulations may be modified to vary the percentages of the ingredients, as would be appreciated by those of ordinary skill in the art. Accordingly, other combinations/percentages of the ingredients may be suitable to meet the taste and texture qualities to satisfy the diverse preferences of consumers and to ensure a broad appeal within the market. In particular, the flexibility in the formulations allows for adaptability to varying tastes, reinforcing the commitment to providing a product that resonates with a wide range of consumer palates.

Moreover, the ingredients of the inventive drink mix are not limited to those specified in the above formulations. In certain embodiments, comparable ingredients or alternative substances may be employed to supplement or substitute with any of the aforementioned ingredients within the formulas. Table 3 below lists the effective substances for some of the ingredients.

TABLE 3

| | Effective | | |
|---|---|---|---|
| Ingredient | Substance | Formula #1 (%) | Formula #2 (%) |
| Extra Fine | sucrose | 70.00 | 22.40 |
| Sugar System | | | |
| Dextrose | glucose | 7.00 | 18.00 |
| Non-dairy creamer | | 6.50 | 17.00 |
| Corn syrup solids | glucose + | 6.00 | 16.00 |
| | fructose | | |
| Nonfat dry milk | lactose | 4.90 | 15.00 |
| Maltodextrin | glucose + | 2.00 | 5.00 |
| | maltose | | |
| Whey protein | | 1.50 | 4.00 |
| Natural & | | 1.00 | 1.50 |
| Artificial Flavor | | | |
| Xanthan gum | | 1.00 | 1.00 |
| Salt | | 0.10 | 0.10 |
| Total | | 100.00 | 100.00 |

As previously mentioned, appropriate substitutes for extra fine sugar system may be employed in various embodiments. Moreover, functional alternatives to any of the ingredients, such as those identified in Table 3 above, may be used in place of the stated ingredients.

The composition of the drink mix of the present invention is specifically formulated to deliver a well-balanced and indulgent frozen fudge drink, offering the ideal combination of sweetness, texture, and flavor enhancement. In the exemplary embodiments, the drink mix includes an extra-fine dry sweetener, a thickener and texture enhancer, and a flavoring agent. When combined with flavored fudge, ice, and water, these components create a rich and creamy frozen fudge drink. Each ingredient has been selected to work synergistically, ensuring a smooth, creamy, and satisfying frozen drink that mirrors the rich taste and consistency of frozen fudge. The components of the drink mix are as follows.

Dry Sweetener: the dry sweetener component is a blend of three key ingredients that provide the desired sweetness profile. In the embodiment, the dry sweetener is selected from a group consisting of the Nulofond® sugar system, the extra fine sugar system, Dextrose, Corn Syrup Solids, Syrup Solids, and combinations thereof.

Extra Fine Sugar System: Included in a range of approximately 22.4% to 70% by weight of the drink mix, this sweetener contributes to the primary sweetness, providing a smooth, refined taste that complements the other ingredients.

Dextrose: Present in a range of approximately 7% to 18% by weight of the drink mix, dextrose is a simple sugar that enhances the overall sweetness with a mild flavor and serves as an energy source in the formulation.

Corn Syrup Solids: Added in a range of approximately 6% to 16% by weight, corn syrup solids offer additional sweetness while improving the texture by increasing the viscosity of the mixture.

In this embodiment, the dry sweetener component includes the extra fine sugar system, dextrose, and corn syrup solids. However, the present invention is not limited to these specific ingredients, and other ingredients capable of achieving the same functional and taste results may also be used.

Thickener and Texture Enhancer: the thickener and texture enhancer component is crucial for achieving the desired consistency and smoothness of the frozen fudge drink. This component includes a combination of the following ingredients.

Xanthan Gum: At approximately 1% by weight of the drink mix, xanthan gum acts as a natural thickening agent, enhancing the viscosity and stabilizing the mixture for a smooth, consistent texture.

Maltodextrin: Present in a range of approximately 2% to 5% by weight, maltodextrin serves as a mild sweetener and bulking agent. It helps improve the texture and control the flow properties of the drink mix.

Non-Dairy Creamer: Contributing approximately 6.5% to 17% by weight, non-dairy creamer provides a rich, creamy texture without dairy, offering a smooth mouthfeel and enhancing the overall body of the drink.

Non-Fat Dry Milk: Present in a range of approximately 4.9% to 15% by weight, non-fat dry milk enhances the creaminess of the drink and adds a dairy-like flavor, improving both the taste and texture.

Whey Protein: Included in a range of approximately 1.5% to 4% by weight, whey protein adds nutritional value while improving the texture by promoting smoothness and providing body to the drink mix.

It is noted that the thickener and texture enhancer in the present invention are not limited to the ingredients listed above, and other suitable ingredients may also be used to achieve the desired texture and consistency.

Flavoring Agent: to achieve the desired taste profile, the flavoring agent in the drink mix is composed of: Natural and Artificial Flavor. Present in a range of approximately 1% to 1.5% by weight of the drink mix, this combination delivers a balanced and enjoyable flavor that mimics the rich taste of frozen fudge. The blend of natural and artificial flavors ensures the flavor remains consistent and intense, enhancing the overall sensory experience of the frozen drink.

Together, these ingredients provide the perfect balance of sweetness, texture, and flavor, resulting in a rich, creamy, and indulgent frozen fudge drink when combined with flavored fudge, ice, and water.

The inventive drink mix when combined and blended with fudge, along with ice and water, in manners to be described, results in an extremely smooth texture. With such embodiments, during consumption there is no sensation of grit. Of course, the fudge that is employed within the present invention preferably should be of extremely high quality to ensure that the final product likewise itself is an extremely high quality product.

As will be appreciated, using extra-fine dry sweetener, in the various embodiments mentioned herein, within the drink mix of the present invention yields improved results, prevents flavor muting, offers a unique microscopic particle composition, exhibits resistance to moisture, and provides a grit-free texture. These qualities collectively enhance the overall quality and appeal of the end product.

As described in further detail below, during production of the frozen fudge drink of the present invention, 1.1 ounces by volume of the inventive drink mix is employed to prepare 16 ounces of the frozen fudge drink. This measurement ensures the perfect equilibrium of flavors and texture in the resulting frozen beverage. The drink mix of the present invention can be a pre-packaged commercial variant readily available in the market or housed in any other packaging specifically designed for containing the drink mix.

### The Flavored Fudge

The inventive frozen fudge drink of the present invention is crafted from the rich and indulgent essence of fudge. Accordingly, fudge plays a crucial and defining role in the invention.

Utilizing fudge in frozen drinks brings forth numerous advantages, encompassing a sumptuous flavor profile, velvety texture, a spectrum of flavors, and visually appealing aesthetics. The inventive frozen fudge drink in its various forms and embodiments distinguishes itself through captivating presentations, unique market positioning, and the potential for positive customer experiences. Moreover, fudge is known for its stability at room temperature, and thus represents an ingredient that is already readily available in retail stores that make and sell fudge to its customers.

The widespread popularity of fudge has initiated a culinary transformation, leading to its presence in a varied selection of flavors, shapes, and colors. FIG. 2 illustrates exemplary fudge with different flavors, shapes, layers and colors (with colors not represented in the figure).

In accordance with the invention, the inventive frozen fudge drink may be made from countless flavors of fudge, including chocolate, peanut butter chocolate, caffè mocha, strawberry, orange cream, cotton candy, and dark chocolate raspberry truffle, to name just a few. Table 4 below shows a larger list of flavors of fudge that may be employed with the present invention. The list is exemplary and non-limiting.

TABLE 4
Exemplary Flavors of Fudge

| | |
|---|---|
| Chocolate | Coffee cookies and cream |
| Peanut butter chocolate | Cappuccino |
| Rocky road | Salted caramel toffee |
| Orange cream | Dulce de leche |
| Strawberries and cream | Raspberry cheesecake |
| Strawberry chocolate | Candy cane |
| Mint chocolate swirl | Salted Caramel |
| Birthday cake | Pumpkin pie |
| Cotton candy | English heath |
| Raspberries and cream | Carmel latte |
| Maple | Red velvet |
| Cookies and cream | Watermelon |
| Caramel Latte | Pumpkin Latte |

### Process of Making Frozen Fudge Drink

In accordance with the invention, the inventive frozen fudge drink is made as follows. Select the flavored fudge to use and cut off a piece. Place in a blender the ingredients of water, the inventive drink mix, the selected fudge (preferably cut into small pieces), and ice. Blend the ingredients till a smooth, delicious frozen fudge drink is created. Then enjoy . . . that is, drink it. The frozen fudge drink optionally can be drunk through a straw.

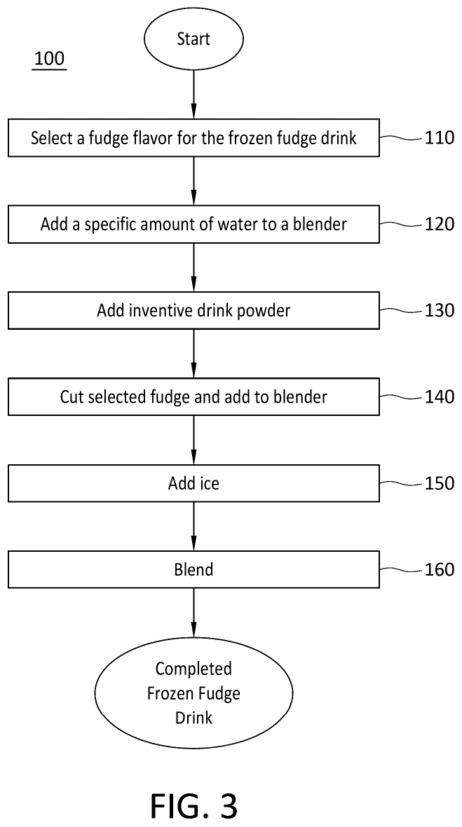

In preferred embodiments, precise quantities of the ingredients are employed. In greater detail, the process of making the inventive frozen fudge drink is described with reference to flowchart 100 shown in FIG. 3.

First, in Step 110, a consumer, store customer or other person selects a particular fudge flavor to use for the frozen fudge drink to be made. As discussed further below, the present invention is particularly well suited to be employed by retail stores that sell a variety of fudge that is freshly made at the retail stores' premises. For instance, a customer selects one of the fudge flavors that have already been made and are currently available for consumption. Or the customer selects a fudge flavor from a menu (e.g., a drink menu). Selection can be made in any manner. If only a single fudge flavor is available, then no selection need be made (i.e., step 110 is omitted).

Thereafter, as indicated in Step 120, a specific amount of water is added to a blender. In general, the amount of water to be added is a function of the ultimate size of the frozen fudge drink. In another embodiment, the amount of water is a function of both the size of the frozen fudge drink and the desired thickness of the drink.

For instance, for a 16 oz. (by volume) frozen fudge drink, 3 ounces of water by volume is used. More or less water is used for a different drink size on a proportional basis.

The blender may be of various types. Based on testing, a Vitamix® 5200 professional-grade blender properly carries out the process. Other suitable blenders that operate comparably to the Vitamix® 5200 professional-grade blender may be employed. For instance, the Vitamix® Commercial 36019, which has programmable buttons, may be used. The blender operation is discussed further below.

After adding the water, a specific amount of the inventive drink mix is added to the blender in Step 130. In preferred embodiments, 1.1 ounces by volume of drink mix is added to produce a 16 oz. (by volume) frozen fudge drink. In other embodiments, more or less amount of drink mix is employed for the same size frozen fudge drink to produce drinks with different textures and flavors. For different size drinks, the amount of drink mix is modified proportionally.

In the retail store environment (as well as in the home or other locations), individual serving size packets of drink mix (e.g., containing 1.1 ounces by volume) may be used for speed, efficiency and cleanliness, wherein a single serving packet may be easily opened (e.g., by tearing or cutting it open) and then poured into the blender without the need to pre-measure the drink mix. Single serve packets suitable for any desired drink size (e.g., 12 oz., 16 oz., 24 oz., etc.) may be manufactured and sold/distributed to retail stores, homeowners, etc. Alternatively, the drink mix may be included in a multi-serving container that includes a measuring scoop that holds 1.1 ounces by volume of drink mix when level. In such case, the appropriate amount of drink mix is quickly obtained via use of the scoop. Other manners of obtaining and dispensing the drink mix may be employed.

Next, the selected fudge is added to the blender in Step 140. In preferred embodiments, one-quarter pound (¼ lb.) of fudge is used for a 16 oz. frozen fudge drink. The fudge can be cut into relatively small pieces at any point in the process before it is added to the blender. For instance, one quarter pound (¼ lb.) of fudge may be cut into four pieces, six pieces, eight pieces, or other number of pieces to make it easier for it to be added to the blender.

The final ingredient of ice is added to the blender in Step 150. In the preferred embodiments, 16 oz. by volume of ice is added to produce 16 fluid ounces of frozen fudge drink.

Blending time may be different. In certain embodiments, the blending time is a function of the type or flavor of the fudge that is selected. For instance, a longer blending time is used, such as 60 seconds, to blend the ingredients in the case of when the fudge is chocolate and/or peanut butter flavored. On the other hand, a shorter blending time is used, such as 35 seconds, for fudge flavors that use a non-chocolate or plain sugar based recipe (e.g., strawberries and cream).

In other embodiments, the blend times are different than the amounts indicated above and may be modified depending on relative thicknesses of the fudge, water/moisture content, the desired thickness of the ultimate drink product, or other factors. Moreover, due to different speed and blending capabilities of different types of blenders, the amounts of time for blending still yet may be modified to accommodate different blender capabilities.

Once blending is complete, the frozen fudge drink is poured into a serving cup for consumption.

As discussed, in one embodiment of the invention, 16 ounces of frozen fudge drink is made from cut-pieces of one-quarter pound (¼ lb. by weight) of fudge, 1.1 ounces by volume of the inventive drink mix, 3 ounces of water by volume, and 16 ounces of ice by volume. If a different drink size is desired, then the quantities are adjusted proportionally. Moreover, as would be appreciated by those in the art, these amounts may be modified. Moreover, the order the ingredients are added to the blender may be modified.

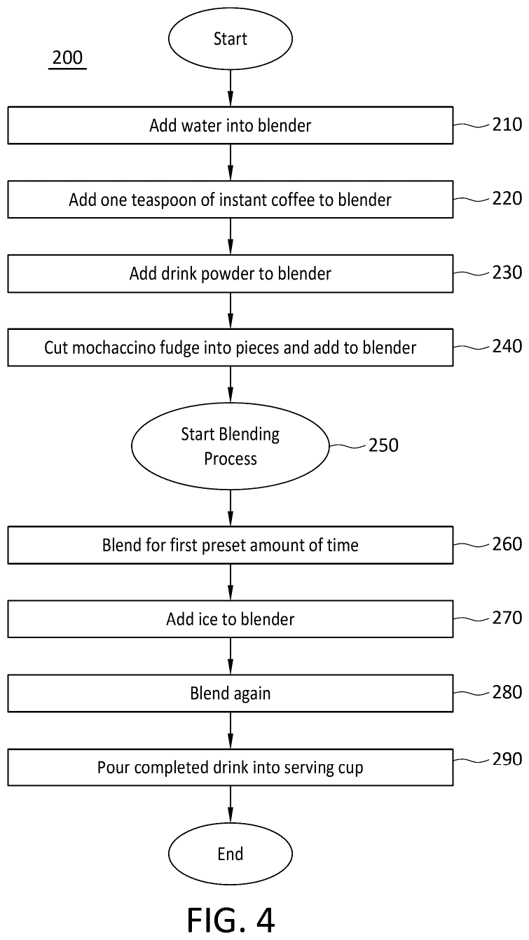

A process of making the inventive frozen fudge drink in accordance with additional embodiments is discussed with reference to the flowchart 200 shown in FIG. 4 below.

In one embodiment that employs the process of FIG. 4, 16 ounces of a frozen fudge drink is made using caffè mocha flavor-based fudge, 1.1 ounces by volume of the inventive drink mix, along with water and ice. In addition, the embodiments described with reference to FIG. 4 further include instant coffee so that the end product is a true caffè mocha frozen drink that includes coffee and chocolate, which is provided in the form of a rich, savory, and smooth frozen drink.

As shown in the flowchart of FIG. 4, three (3) ounces of water is placed in a blender in Step 210 and then a level teaspoon (e.g., 1 serving) of instant coffee is added to the blender in Step 220.

Although not shown in FIG. 4, one or more additional flavoring ingredients can be added to the blender. For example, vanilla, caramel, strawberry or other flavorings may be added. The flavorings may be in the form or an extract, a cut piece of fruit, or in any other form suitable to be added to a drink.

The inventive drink mix is added to a blender in Step 230. In a preferred embodiment, 1.1 ounces by volume of the drink mix is added, although this amount can change if desired. In other embodiments, the amount of the drink mix can differ as mentioned in the other embodiments/variations discussed above in connection with the flowchart of FIG. 3.

Next, a one-quarter pound (¼ lb.) piece of caffè mocha fudge is cut into several smaller pieces and then added to the blender in Step 240.

With all the ingredients now added to the blender (except for ice), the operator starts the blending process in Step 250. In the embodiments of the flowchart of FIG. 4, the blending process is multi-stage to provide a drink product that readily flows, is smooth to the palate, and devoid of large ice particles, yet contains grains of ice to provide a frozen mouth feel.

In the first stage of the blending process, the ingredients are blended for a first preset amount of time in Step 260. In one version, this amount of time is 20 seconds, although the amount of time can be modified if desired.

After the initial blending stage, the blender's lid is removed, and 16 ounces of ice by volume is added to the blender in Step 270. The lid is placed back on the blender. The ingredients, now with ice included, are blended during a second blending stage for 20 seconds, in Step 280.

Finally, the operator removes the lid and pours the completed drink product into a 16 oz. serving cup in Step 290. Optionally, a straw is added and the serving cup that contains a caffè mocha-flavored frozen fudge drink is provided to a customer or other person.

With respect to the process described in connection with the flowchart in FIG. 4, further embodiments may be employed that are the same or similar to those described with respect to FIG. 3, as well as the other embodiments/variations discussed herein.

In the various embodiments described, if the completed frozen fudge drink in the blender is too thick to pour, a long-handled spoon may be used to scoop out the frozen drink and placed within the serving cup.

Table 5 below presents a recipe that may be used by retailers and other entities and persons for making the inventive frozen fudge drink using chocolate fudge or peanut butter fudge. Table 6 below presents a recipe for making the inventive frozen fudge drink using vanilla fudge.

TABLE 5

| | |
|---|---|
| For Chocolate Fudge | 3 oz. water |
| Based Recipes | 1 scoop (1.1 oz.) of the inventive drink mix |
| & Peanut Butter | ¼ lb of chocolate fudge |
| Fudge Based Recipes | 16 oz by volume of ice |
| | Mix in Program 1 (fastest mode for 60 seconds) |
| | In need of more blending, please use High Pulse |
| | button between 5-10 seconds. |

TABLE 6

| | |
|---|---|
| For Vanilla Fudge | 3 oz. water |
| Based Recipes | 1 scoop (1.1 oz.) of the inventive drink mix |
| | ¼ lb of vanilla fudge |
| | 16 oz by volume of ice |
| | Mix in Program 2 (fastest mode for 35 seconds) |
| | In need of more blending, please use “High Pulse” |
| | button between 5-10 seconds. |

As mentioned earlier, additional flavorings may be added to the blender before the frozen fudge drink is complete. In yet further embodiments, the process of FIG. 4 may be modified to replace instant coffee with a different ingredient, such as fresh fruit, chocolate, caramel, vanilla, or other desired flavor, in any suitable form. Similarly, any additional ingredient may be added to the blender in the process described in connection with FIG. 3 before the frozen fudge drink is completely made.

### Automated Blending

In accordance with further embodiments of the invention, any of the embodiments described herein may be partially automated by pre-programming the blender to carry out mixing for a preset or preprogrammed period of time. Programming may further include presetting the mixing speed.

In one embodiment, a Vitamix® Commercial 36019 blender, which has six (6) programmable buttons, is pre-programmed to carry out blending in accordance with a user-selected mode. For instance, a first mode is programmed to blend at the blender's fastest speed for 60 seconds, which optimizes the blending of chocolate and peanut butter flavored frozen fudge drinks. As another example, the blender is programmed to blend when a second mode is selected at the blender's fastest speed for 35 seconds, which is well-suited to blend non-chocolate based frozen fudge drinks.

The above modes are exemplary, and these modes may vary depending on the types of fudge employed, other ingredients that may be added, the amount of ice that is used, and/or other factors. In some cases, the blender is preprogrammed to blend at a speed that is lower than the blender's highest speed.

In still yet other embodiments, the blender is programmed to blend in a first mode for a preset period of time, followed by a second mode for another preset period of time. In one case, each mode begins upon user initiation (e.g., push of a suitable button on the blender) to allow the user time to get the ingredients within the blender. Such embodiments are well suited to carry out the blending process described in the process carried out in FIG. 4. As discussed, the blending process includes two separate blending operations. In yet further embodiments, additional modes of operation may be employed.

### Additional Benefits and Features

Generally depending on the power of the blender, ice cubes of various types may be employed without difficulty. For example, by employing the Vitamix® 5200 blender, which includes a 2 horsepower motor, allows for the preparation of frozen fudge drink in accordance with the present invention using ice of nearly any size that is commercially available in retail stores or produced by commercial ice-making machines. Hence, with a blender with a 2 horsepower motor, or similar or larger size, the present invention can use ice of any shape or size that would be employed by a homeowner or a retail store in the business of making and selling fudge and drinks to customers.

In the various embodiments described, the frozen fudge drink exhibits a consistency that allows for easy flow, which in turn allows for the frozen fudge drink to be drawn through a 3/16-inch straw for consumer consumption. Moreover, the frozen fudge drink will have sufficient viscosity (i.e., thickness) to support the straw when the straw is inserted into the serving cup that contains the completed frozen fudge drink.

In one set of embodiments of the invention, a retail store that is in the business of selling multiple flavors of fudge to its customers now may practice the present invention for its customers. In particular, the process comprises a customer entering the retail store and observing any number of flavors of fudge for purchase. The customer then selects a desired flavor of fudge to be used to make the inventive frozen fudge drink. The operator of the retail store (or any designated person) then follows the various steps of any of the embodiments described herein to produce the frozen fudge drink using the customer's desired fudge flavor. Beneficially, since the retail store will likely have multiple flavors of fudge for purchase, the present invention enables the retail store to make the inventive frozen fudge drink extremely quickly and easily, in accordance with the processes/steps described herein.

The present invention is not limited to being carried out in retail stores, and may be implemented in one's home, at a school (e.g., in a school cafeteria), at a fundraising function, at a kiosk, or pretty much at any location where the ingredients for the frozen fudge drink are available and a suitable blender can be used as described herein.

As illustrated, the tools that are needed to implement the processes described herein are few and include a blender and one or more tools for measuring out the ingredients (if necessary). Such tools include a knife, spatula or other appropriate tool to cut the fudge, a tool (e.g., tablespoons, teaspoons, measuring cup(s)) to measure the inventive drink mix, a measuring cup or scale to measure the proper amount of ice to add, etc. The measuring tools may not be needed where pre-made single serving portions are provided (e.g., single-serving drink mix packets). Regardless of how the ingredients are measured, the sole piece of electric/power equipment is the blender. Other electric or powered devices are not needed.

In accordance with another benefit and feature of the invention, the ingredients (except for the ice) do not require refrigeration. Fudge, the inventive drink mix and water are stable at room temperature thus providing retailers, homeowners and other persons additional convenience as well as portability.

Other variations may be made to the various embodiments described herein as would be appreciated to those of ordinary skill in the art. As mentioned, the order of adding the ingredients to a blender may be modified. The flavors and amounts of the ingredients may be suitably modified. Additional ingredients may be added if desired and appropriate to one's tastes and preferences.

In brief summary, the inventive frozen fudge drink includes a select flavor of fudge, an inventive drink mix, water, and ice, which are then blended to produce the frozen fudge drink. Preferably, the drink mix includes extra-fine dry sweetener which is a sucrose-based fondant mixture.

As an aspect of the drink mix, the Nulofond® sugar system (or equivalent) is employed as the sweetener. Table 1 shows a formulation in accordance with another specific embodiment of the drink mix. Table 2 shows another formulation in accordance with another specific embodiment of the drink mix. Other embodiments and versions are as described above.

In a variation, a caffè mocha flavored frozen fudge drink is made by adding to a blender: water, instant coffee, drink mix, and cut pieces of flavored fudge; blending the ingredients for a set amount of time; then adding ice to the blender, and blending the ingredients again. Further details and variations are as described herein.

In addition, for each of the embodiments (and variations thereof) described herein, some ingredients of the drink mix may be replaced by a corresponding effective substance as identified in Table 3.

In the various embodiments described herein, the amount of ice to be used is described in terms of by volume. To ensure that the amount of ice is appropriate, measuring ice by volume is acceptable so long as the ice that is used is no larger than 2″×2″×2″ in size. Other appropriate precautions may be employed to make sure that the proper amount of ice is used.

The present invention further provides an inventive method of making a customizable frozen fudge drink. According to one embodiment of the present invention, the method comprises the steps of selecting a flavored fudge based on a user's selection; adding a predetermined amount of water to a blender; adding a predetermined amount of drink mix to the blender; cutting the flavored fudge into pieces and adding the pieces of the flavored fudge to the blender; adding ice; and blending all the above ingredients.

According to further aspects, one or more additional flavoring ingredients are added to the blender. According to yet another embodiment, the blending step is performed by a pre-programmed blender. As a feature of this embodiment, the blender is programmed to blend in at least two modes, with a first mode for blending a first preset period of time at a first preset speed, and a second mode for blending a second preset period of time at a second preset speed. As features, the first and second modes are selected based on the flavor of the fudge.

As illustrated from the foregoing discussion, the present invention not only revolutionizes the texture and flavor profiles of frozen fudge beverages but also introduces an innovative consumption method for fudge. By transforming fudge from a solid to a liquid frozen form, this invention expands the culinary applications of fudge, offering consumers a novel and enjoyable way to experience its flavors. This method presents a significant market opportunity, particularly appealing as a refreshing option in warmer climates or as a distinctive dessert alternative, thereby broadening the consumer base and enhancing the commercial viability of fudge products.

Other variations may be made as would be appreciated to those of ordinary skill in the art. Therefore, it is to be understood that other expedients/variations/embodiments may be employed but that stay within the meaning, scope and spirit of the invention.

Having described the present invention including the various features and variations thereof, it is intended that the appended claims be interpreted as including the embodiments described herein, the alternatives mentioned above, and all equivalents thereto.

What is claimed is:

1. A fudge-based beverage, comprising:
a blended combination of:
flavored fudge;
a powdered drink mix having at least an extra fine dry sweetener and a thickener;
water;
ice.

2. The fudge-based beverage of claim 1, wherein the extra fine dry sweetener includes a sucrose-based extra fine dry sweetener with at least 89% of particles, with agglomerates broken down, having a size smaller than or equal to 44 microns.

3. The fudge-based beverage of claim 1, wherein the extra fine dry sweetener includes a sucrose-based extra fine dry sweetener with at least 85% of particles, with agglomerates broken down, having a size smaller than or equal to 44 microns.

4. The fudge-based beverage of claim 1, wherein the extra fine dry sweetener includes a sucrose-based extra fine dry sweetener with an average particle size, with agglomerates broken down, of between 27 and 31 microns.

5. The fudge-based beverage of claim 1, wherein the extra fine dry sweetener includes a sucrose-based extra fine dry sweetener with an average particle size, with agglomerates broken down, of substantially 29 microns.

6. The fudge-based beverage of claim 1, wherein the powdered drink mix comprises:
sucrose-based extra fine dry sweetener that is substantially 22.4% by weight of the powdered drink mix;
dextrose that is substantially 18% by weight of the powdered drink mix;
corn syrup solid that is substantially 16% by weight of the powdered drink mix;
non-fat dry milk that is substantially 15% by weight of the powdered drink mix; and
at least one additional ingredient to affect at least one of texture, flavor, consistency, whitening, and stabilization.

7. The fudge-based beverage of claim 6, wherein the powdered drink mix includes:
xanthan gum that is substantially 1% by weight of the powdered drink mix;
maltodextrin that is substantially 5% by weight of the powdered drink mix;
non-dairy creamer that is substantially 17% by weight of the powdered drink mix;
non-fat dry milk that is substantially 15% by weight of the powdered drink mix;
whey protein that is substantially 4% by weight of the powdered drink mix; and
top flow table salt that is substantially 0.1% by weight of the powdered drink mix.

8. The fudge-based beverage of claim 1, wherein the powdered drink mix comprises:
sucrose-based extra fine dry sweetener that is substantially 70% by weight of the powdered drink mix;
dextrose that is substantially 7% by weight of the powdered drink mix;
corn syrup solid that is substantially 6% by weight of the powdered drink mix;
non-fat dry milk that is substantially 4.9% by weight of the powdered drink mix; and
at least one additional ingredient to affect at least one of texture, flavor, consistency, whitening, and stabilization.

9. The fudge-based beverage of claim 1, wherein the powdered drink mix comprises:
sucrose-based extra fine dry sweetener that is between 22.4% to 70% by weight of the powdered drink mix;
dextrose that is between 7% to 18% by weight of the powdered drink mix;
corn syrup solid that is between 6% to 16% by weight of the powdered drink mix; and
non-fat dry milk that is between 4.9% to 15% by weight of the powdered drink mix.

10. The fudge-based beverage of claim 1, wherein 16 ounces of the blended combination include:
¼ pound by weight of the flavored fudge;
1.1 ounces by volume of the powdered drink mix;
3 ounces by volume of water; and
16 ounces by volume of ice.

11. The fudge-based beverage of claim 1, wherein the blended combination includes instant coffee.

12. The fudge-based beverage of claim 1, wherein all ingredients of the fudge-based beverage, except for the ice, are stable at room temperature.

13. A method of producing a fudge-based blended beverage, comprising:
obtaining a flavored fudge;
cutting the flavored fudge into pieces and adding the pieces of the flavored fudge to a blender;
adding a predetermined amount of powdered drink mix that has at least an extra fine dry sweetener and a thickener to the blender;
adding a predetermined amount of water to a blender;
adding ice to the blender; and
blending the flavored fudge, water, powdered drink mix, and ice to produce the fudge-based blended beverage.

14. The method of claim 13, comprising selecting the flavored fudge from a plurality of pre-made flavored fudges.

15. The method of claim 13, wherein:
blending is carried out by a pre-programmed blender in accordance with a first mode corresponding to a first preset period of time at a first preset speed of operation or in accordance with a second mode corresponding to a second preset period of time at a second preset speed of operation, the first and second preset periods of time being different;
wherein blending is carried out by the blender in the first mode or in the second mode based on a flavor of the flavored fudge added to the blender.

16. The method of claim 13, wherein the extra fine dry sweetener includes a sucrose-based extra fine dry sweetener with at least 89% of particles, with agglomerates broken down, having a size smaller than or equal to 44 microns.

17. The method of claim 13, wherein the extra fine dry sweetener includes a sucrose-based extra fine dry sweetener with at least 85% of particles, with agglomerates broken down, having a size smaller than or equal to 44 microns.

18. The method of claim 13, wherein the extra fine dry sweetener includes a sucrose-based extra fine dry sweetener with an average particle size, with agglomerates broken down, of between 27 and 31 microns.

19. The method of claim 13, wherein the extra fine dry sweetener includes a sucrose-based extra fine dry sweetener with an average particle size, with agglomerates broken down, of substantially 29 microns.

20. The method of claim 13, wherein the powdered drink mix comprises:
sucrose-based extra fine dry sweetener that is substantially 22.4% by weight of the powdered drink mix;
dextrose that is substantially 18% by weight of the powdered drink mix;
corn syrup solid that is substantially 16% by weight of the powdered drink mix;
non-fat dry milk that is substantially 15% by weight of the powdered drink mix; and
at least one additional ingredient to affect at least one of texture, flavor, consistency, whitening, and stabilization.

21. The method of claim 20, wherein the powdered drink mix includes:
xanthan gum that is substantially 1% by weight of the powdered drink mix;
maltodextrin that is substantially 5% by weight of the powdered drink mix;
non-dairy creamer that is substantially 17% by weight of the powdered drink mix;
non-fat dry milk that is substantially 15% by weight of the powdered drink mix;
whey protein that is substantially 4% by weight of the powdered drink mix; and
top flow table salt that is substantially 0.1% by weight of the powdered drink mix.

22. The method of claim 13, wherein the powdered drink mix comprises:
sucrose-based extra fine dry sweetener that is substantially 70% by weight of the powdered drink mix;
dextrose that is substantially 7% by weight of the powdered drink mix;
corn syrup solid that is substantially 6% by weight of the powdered drink mix;
non-fat dry milk that is substantially 4.9% by weight of the powdered drink mix; and
at least one additional ingredient to affect at least one of texture, flavor, consistency, whitening, and stabilization.

23. The method of claim 13, wherein the powdered drink mix comprises:
sucrose-based extra fine dry sweetener that is between 22.4% to 70% by weight of the powdered drink mix;
dextrose that is between 7% to 18% by weight of the powdered drink mix;
corn syrup solid that is between 6% to 16% by weight of the powdered drink mix; and
non-fat dry milk that is between 4.9% to 15% by weight of the powdered drink mix.

24. The method of claim 13, comprising:
determining an amount of the fudge-based blended beverage to produce;
providing at least ¼ pound by weight of the flavored fudge;
providing at least 1.1 ounces by volume of the powdered drink mix;
providing at least 3 ounces by volume of water;
providing at least 16 ounces by volume of ice;
proportionally adjusting amounts of all ingredients to be added to the blender if the determined amount of the fudge-based blended beverage to produce is different from 16 ounces.

25. The method of claim 13, wherein all ingredients added to the blender, except for the ice, are stable at room temperature.

26. The method of claim 13, comprising adding instant coffee to the blender prior to the blending step.

27. The method of claim 13, comprising, prior to the blending step, adding to the blender at least one additional ingredient selected from the group consisting of vanilla, caramel, and a cut piece of fruit.

28. The method of claim 13, comprising:
carrying out a first blending step for a first predetermined period of time before the ice is added to the blender to blend the pieces of flavored fudge, the powdered drink mix, and the water to produce a first blended combination;
wherein the adding ice to the blender step is carried out by adding ice to the blender having the first blended combination; and
wherein the step of blending the flavored fudge, water, powdered drink mix, and ice to produce the fudge-based blended beverage is carried out for a second predetermined period of time after the first blending step and after the ice is added to the blender, the first and second periods of time being different.

29. The method of claim 28, wherein both blending steps are carried out by a pre-programmed blender having at least two modes of operation in which blending the pieces of flavored fudge, the powdered drink mix, and the water to produce the first blended combination during the first blending step is automatically carried out for said first predetermined period of time upon user initiation of a first mode of operation of the blender; and
wherein the step of blending the flavored fudge, water, powdered drink mix, and ice to produce the fudge-based blended beverage is automatically carried out for the second predetermined period of time upon user initiation of a second mode of operation of the blender.

30. A composition of a powdered drink mix for use to produce a fudge-based beverage, comprising:
a sucrose-based extra fine dry sweetener with at least 85% of particles, with agglomerates broken down, having a size smaller than or equal to 44 microns;
a thickener
a texture enhancer; and
a flavoring agent.

31. The composition of claim 30, wherein the sucrose-based extra fine dry sweetener includes at least 89% of the particles, with agglomerates broken down, having a size smaller than or equal to 44 microns.

32. The composition of claim 30, wherein the sucrose-based extra fine dry sweetener has an average particle size, with agglomerates broken down, of between 27 and 31 microns.

33. The composition of claim 30, wherein the sucrose-based extra fine dry sweetener has an average particle size, with agglomerates broken down, of substantially 29 microns.

34. The composition of claim 30, comprising:
the sucrose-based extra fine dry sweetener that is substantially 22.4% by weight of the powdered drink mix;
dextrose that is substantially 18% by weight of the powdered drink mix;
corn syrup solid that is substantially 16% by weight of the powdered drink mix;
non-fat dry milk that is substantially 15% by weight of the powdered drink mix; and
at least one additional ingredient to affect at least one of texture, flavor, consistency, whitening, and stabilization.

35. The composition of claim 34, comprising:
xanthan gum that is substantially 1% by weight of the powdered drink mix;
maltodextrin that is substantially 5% by weight of the powdered drink mix;
non-dairy creamer that is substantially 17% by weight of the powdered drink mix;
non-fat dry milk that is substantially 15% by weight of the powdered drink mix;
whey protein that is substantially 4% by weight of the powdered drink mix; and
top flow table salt that is substantially 0.1% by weight of the powdered drink mix.

36. The composition of claim 30, comprising:
the sucrose-based extra fine dry sweetener that is substantially 70% by weight of the powdered drink mix;
dextrose that is substantially 7% by weight of the powdered drink mix;
corn syrup solid that is substantially 6% by weight of the powdered drink mix;
non-fat dry milk that is substantially 4.9% by weight of the powdered drink mix; and
at least one additional ingredient to affect at least one of texture, flavor, consistency, whitening, and stabilization.

37. The composition of claim 30, comprising:
sucrose-based extra fine dry sweetener that is between 22.4% to 70% by weight of the powdered drink mix;
dextrose that is between 7% to 18% by weight of the powdered drink mix;
corn syrup solid that is between 6% to 16% by weight of the powdered drink mix; and
non-fat dry milk that is between 4.9% to 15% by weight of the powdered drink mix.
